(19) United States
(12) Patent Application Publication
(10) Pub. No.: US 2023/0172393 A1
(43) Pub. Date: Jun. 8, 2023

(54) COORDINATED COOKING SYSTEM AND METHOD

(71) Applicant: June Life, Inc., San Francisco, CA (US)

(72) Inventor: Nikhil Bhogal, San Francisco, CA (US)

(21) Appl. No.: 17/311,663

(22) PCT Filed: Dec. 18, 2020
(86) PCT No.: PCT/US2020/066014

§ 371 Date: Jun. 7, 2021

Related U.S. Application Data
(60) Provisional application No. 62/949,844, filed on Dec. 18, 2019.

(51) Int. Cl. A47J 36/32; A47J 44/00; G06F 16/9535

(52) U.S. Cl. CPC A47J 36/321; A47J 44/00; G06F 16/9535

(57) ABSTRACT

The cooking coordination method includes: determining a menu S110; determining available resources S 120; determining a cooking schedule based on the menu S130; and instructing the resources according to the cooking schedule S140. The method can optionally include: monitoring cooking progress S150; and determining instruction completion S160. The method functions to automatically coordinate a set of resources to cooperatively cook a menu (e.g., recipe set). Invariants, the method functions to coordinate the set of resources such that cooking is completed at the same time.

### CROSS-REFERENCE TO RELATED APPLICATIONS

This application claims the benefit of U.S. Provisional App. No. 62/949,844 filed 18-DEC-2019, which is incorporated in its entirety by this reference.

### TECHNICAL FIELD

This invention relates generally to the cooking technology field, and more specifically to a new and useful system and method for cooking coordination in the cooking technology field.

### BRIEF DESCRIPTION OF THE FIGURES

FIG. 1 is a schematic representation of the method.

FIG. 2 is a schematic representation of the system.

FIG. 3 is a schematic representation of a variant of the system.

FIG. 4 is a schematic representation of an example of determining a cooking schedule based on instruction sets for a first and second recipe.

FIG. 5 is a schematic representation of a specific example of determining a first and second cooking schedule based on a first and second recipe, using two different available sets of resources.

FIG. 6 is a schematic representation of a specific example of a recipe.

FIG. 7 is a schematic representation of a variant of the method.

FIG. 8 is a schematic representation of a variant of the method.

FIG. 9 is a schematic representation of a variant of the method.

FIG. 10 is a schematic representation of an example of instructing resources according to the cooking schedule.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1 Overview

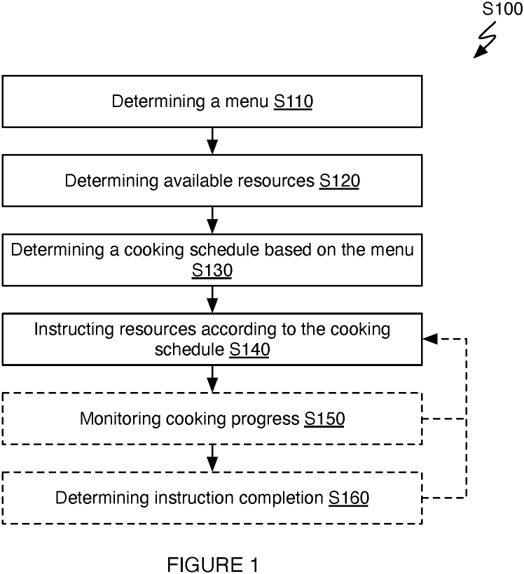

As shown in FIG. 1, the cooking coordination method includes: determining a menu Sno; determining available resources S120; determining a cooking schedule based on the menu S130; and instructing the resources according to the cooking schedule S140. The method can optionally include: monitoring cooking progress S150; and determining instruction completion S160. The method functions to automatically coordinate a set of resources to cooperatively cook a menu (e.g., recipe set). In variants, the method functions to coordinate the set of resources such that cooking is completed at the same time. However, the method can include any other suitable elements.

### 2. Benefits

The method can confer several benefits over conventional systems and methods.

First, variants of the method can decrease a user’s cognitive load by automatically planning and – in variants – coordinating resource operation to automatically perform different steps of the cooking process, such as obtaining groceries or cooking (portions of) the meal. This can enable a novice to cook advanced recipes. Further, variants of the method can provide notification driven instructions to the user on an as-needed basis, enabling the user to focus on information pertinent to a current step (e.g., without requiring foresight of future steps for dish timing purposes). Similarly, the method can provide a notification driven start time - which can indicate when a user should begin preparation of a meal to achieve a predetermined mealtime. When preparing a menu (e.g., multiple recipes), this can be particularly advantageous, since the duration of menu preparation can be difficult for users to estimate when multiple recipes therein are prepared concurrently and rely on inter-recipe step dependencies which obfuscate the total cooking duration. The method can further decrease a user’s cognitive load by notifying the user of the estimated time until prior step completion and/or the estimated time until next step commencement. Such variants can include automatic step execution – such as automatic preheating or delayed cooking of a foodstuff precursor within an oven volume – without the intervention of the user. Further, variants can ensure that cooking of all recipes or dishes are completed concurrently (or, in the case of a multi-course menu, at a predetermined course time), so that food does not degrade (e.g., hot food cooling off, etc.) in the intervening period before a remainder of the recipes or dishes are cooked.

Second, variants of the method can accommodate for differences between different users’ available resources, tools, and ingredients by dynamically determining the cooking schedule based on the respective user’s resources.

Third, variants of the method can also enable a facile user experience by automatically combining redundant steps across recipes, batching steps (across recipes) that require the same tool (e.g., in the same state), accounting for thermodynamic properties (e.g., prioritizing steps that require a lower-temperature state for a given resource, accounting for faster heating than cooling), and/or accounting for other rules or heuristics when creating the cooking schedule.

Fourth, variants of the method can provide a personalized meal experience, which can account for user preferences (e.g., dietary restrictions, cuisine preferences, etc.) when planning. Such data can be used to improve the accuracy of cook time estimation and, accordingly, the assignment of inter-recipe dependencies (e.g., to yield simultaneous cooking completion).

However, variants of the system and/or method can confer any suitable set of benefits.

### 3 System

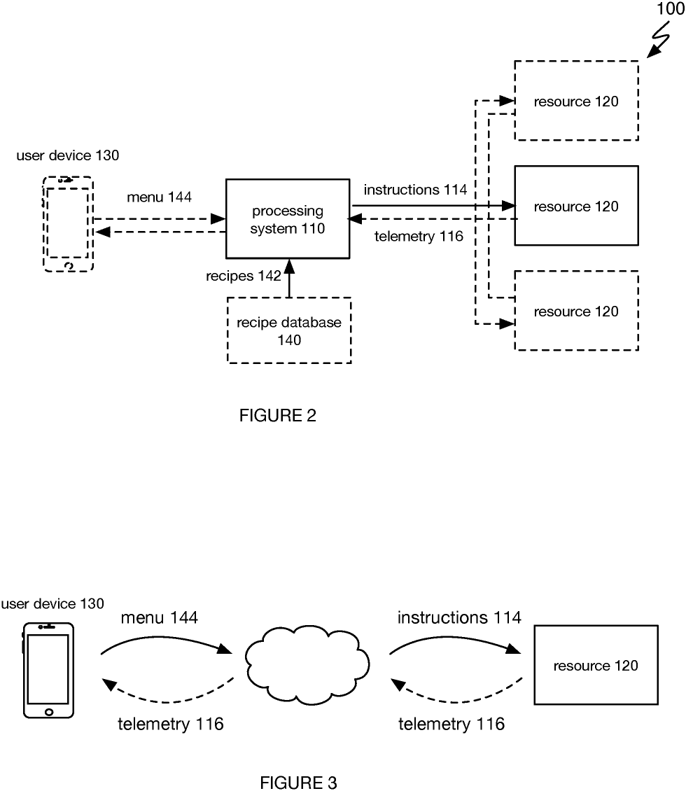

The method is preferably performed with a system 100 including a processing system 110 and a set of resources 120 (examples shown in FIG. 2 and FIG. 3), but can additionally or alternatively be performed with any other suitable system. The resources can include one or more: user devices, appliances, tools, ingredients, and/or any other suitable auxiliary component.

The processing system of the system functions to perform the method. The processing system is preferably a remote computing system (e.g., a centralized server system, etc.), but can additionally or alternatively be: a local computing system (e.g., onboard a resource, such as the processing system of an oven); a distributed system; a user device; and/or any other suitable processing system. When the processing system is remote or distinct from the resources, the processing system preferably transmits information (e.g., instructions) to and/or receives telemetry 116 (e.g., sensor data, resource states, etc.) from the resources. The processing system can optionally receive information (e.g., recipe selections for a menu 144, user preferences, user data, etc.) from one or more user devices 130, and transmit information (e.g., telemetry, notifications, etc.) to the user devices 130. The system preferably includes a single processing system, but can additionally or alternatively include multiple processing systems or processing system instances (e.g., for different cook sessions, different users, etc.).

The physical computing hardware of the processing system can include: CPUs, GPUs, microprocessors, servers, cloud computing, and/or any other suitable components. Additionally, the computing hardware can include non-volatile computer readable medium storing instructions, software modules, and/or various databases (e.g., recipe database, user database, resource database, etc.). Non-volatile memory can include: F-RAM, ROM, flash memory, and/or any other suitable memory. Additionally or alternatively the system can include volatile memory (e.g., RAM) and/or any other suitable memory storage components.

The processing system can communicate via a wired and/or wireless communication channels with various resources. Preferably, the processing system can communicate wirelessly via Bluetooth, Wi-Fi, short-range wireless signals, and/or any other suitable wireless channels. Alternatively, the processing system can communicate via a wired connection (e.g.; Ethernet; integrated into a user device or connected appliance; etc.). The processing system can be configured to exchange data with any suitable resources in a push and/or pull configuration. In a first example, the processing system can push notifications to the user device (e.g., in response to completion of a step, based on a current time, etc.). In a second example, a user device can request (pull) information from the processing system. The processing system can enable synchronous, asynchronous, periodic, aperiodic, continuous, discrete, and/or other suitable communication frequency with the various resources (and/or user devices). However, the processing system can otherwise suitably communicate with the various resources (and/or user devices).

The system can include one or more resources which can be employed to execute portions of the method. Examples of resources include: users, tools (e.g., knives, accessories), cooking appliances (e.g., connected appliances, unconnected appliances), or other cooking resources.

Resources can be associated with a user account and/or can be stored/tagged within a resource database (e.g., same or different from the user database). Resources can be associated with resource parameters such as: capabilities or technical specifications, a quantity or number (e.g., associated with the account), a current and/or estimated state (e.g., availability; temperature; degree of fullness; connectivity state, such as powered or connected; cleanliness state, such as contaminated or clean; availability, such as occupied or empty; occupancy level, such as full or half full; operation state or mode; etc.), preheat time, cooling time, and/or any other suitable resource parameters. Resources can optionally be associated with one or more sensors, which can monitor resource parameters and/or foodstuff parameters (e.g., of the foodstuff managed by the resource). Resource sensors can include: optical sensors (e.g., image sensors, light sensors, etc.), audio sensors, temperature sensors, volatile compound sensors, weight sensors, humidity sensors, depth sensors, location sensors, inertial sensors (e.g., accelerators, gyroscope, magnetometer, etc.), impedance sensors (e.g., to measure bio-impedance of foodstuff), hygrometers, insertion temperature sensors (e.g., probes), cooking cavity temperature sensors (e.g., within the interior of an appliance), timers, gas analyzers, pressure sensors, flow sensors, door sensors (e.g., a switch coupled to the door, etc.), power sensors (e.g., Hall effect sensors), or any other suitable sensor. The sensors can be arranged in: a cooking cavity (e.g., top, bottom, side, corners, front, back, etc.), a handle, a body, a base, or other portion of the resource; be separate from the resource (e.g., arranged to monitor the resource); or be otherwise arranged. The sensors can be connected to and controlled by the processing system, or be otherwise controlled. The sensors are preferably individually indexed and individually controlled, but can alternatively be controlled together with other like sensors. The resource parameters and/or foodstuff parameters can be determined and/or analyzed: locally (e.g., on the resource, by the resource), remotely (e.g., by a remote computing system, by a centralized processing system, etc.), or otherwise determined.

One or more resources can be operable between one or more operation modes or states. One or more resources are preferably automatically controllable (e.g., include an on-board processing system capable of automatically executing control instructions received from the processing system), but can additionally or alternatively be manually controllable (e.g., based on a knob, touchscreen, or other user input; directly user operated), or otherwise controllable. Resources are preferably communicably connected to the processing system, but can additionally or alternatively be disconnected from the processing system. A resource can be directly or indirectly connected to the processing system via a wired or wireless connection, such as the Internet, a cellular connection, a LAN, a short-range connection such as Bluetooth or NFC, or other connection.

A resource 120 preferably functions to execute resource instructions 114 to transform the ingredient (foodstuff) or tool state, but can additionally or alternatively sample sensor measurements (e.g., of the resource, of the food), transmit resource information (e.g., sensor measurements, resource states, etc.) to the processing system, and/or perform any other suitable functionality. Resources can include users, APIs (e.g., grocery store API), cooking appliances 122, auxiliary appliances (e.g., non-cooking appliances, appliances which do not condition food, etc.), tools, and/or any other suitable resources.

Cooking appliances can include indoor appliances, outdoor appliances, static appliances, mobile appliances, and/or any other suitable appliances. Cooking appliances can provide heating, cooling, physical manipulation, and/or other capabilities. In variants, cooking appliances can define one or more food cavities configured to receive and treat foodstuff. Alternatively, foodstuff can define an external surface or region configured to treat the foodstuff and/or otherwise suitably condition the foodstuff. Food conditioning can include conditioning using multiple independently controlled zones (e.g., wherein each zone can be treated as a different appliance by the system, or be treated as the same appliance) or a single zone. In a first example, different burners or heating pads on a stove can define independent heating zones. In a second example, an oven can include different heating zones. In a third example, an appliance with an integrated freezer and refrigerator can define two cooling zones (e.g., with temperatures below and above the freezing point of water, respectively). Examples of cooking appliances can include: a grill, oven, sous vide cooker, cooktop/stove (e.g., induction, gas), pressure cooker, air fryer, stand mixer, extruder, dehydrator, microwave, refrigerator, freezer, smoker, and/or any other suitable cooking appliances. The foodstuff preparation appliances can have any suitable relationship to other appliances within the resource set and can provide the same functionalities/capabilities (e.g., heating, heating by conduction, heating by convection, etc.) and/or different functionalities/ capabilities.

Cooking appliances (and/or resources) can be connected or unconnected. Connected appliances can have communication capabilities (e.g., via WiFi, Bluetooth, cellular, internet, LAN, Ethernet, etc.), be remotely controllable, and/or otherwise characterized. The connected appliances preferably communicate with the processing system (e.g., send sensor telemetry, receive instructions, etc.), but can alternatively communicate with other appliances, other devices, or other endpoints (e.g., using the same or different operating system, communication protocol, etc.). Unconnected appliances can lack communication capabilities, lack remote control abilities, and/or be otherwise characterized. Both connected and unconnected appliances can be: locally controllable (e.g., manually controllable), powered, unpowered, or have other characteristics.

The auxiliary appliances can include cleaning appliances (e.g., dishwasher), ventilation equipment, monitoring devices, lighting, and/or any other suitable auxiliary appliances.

The tools can include any measuring cups, utensils, knives, cutting boards, bowls, spatulas, pots, pans, temperature probes (e.g., with communication capabilities, without communication capabilities), resource accessories (e.g., trays, racks, spatulas, brushes, etc.), cleaning apparatus (e.g., mops, , and/or other suitable tools. Tools can be associated with tool type (e.g., type identifier), tool identifier (e.g., unique tool identifier, such as first spatula, second spatula, etc.), tool characteristics (e.g., tool parameters), the tool amount (e.g., numerosity), the tool state (e.g., clean, contaminated, etc.), and/or any other suitable parameter. Tool characteristics can include a dimension or size (e.g., a depth of pots or bowls, a volume of pots or bowls, an area of baking trays, a knife length, etc.), a material (e.g., stainless steel, glass, etc.) and/or any other suitable characteristics. Tool characteristics can enable differentiation of tools for most appropriate application in a recipe, optimization of a recipe according to available tools, modification of recipe to accommodate for available tools (e.g., scale down recipe to fit within largest available pot), selection of a recipe based on the available tools (e.g., number of tools having the tool characteristics associated with the recipe), and/or have any other suitable application.

The processing system can include a recipe database 140 which functions to store one or more recipes 142. The system can include one or more recipe databases (e.g., for different geographic regions, different users, different user groups, etc.). The recipe database is preferably stored in a remote computing system (e.g., the same or different from that executing the processing system), but can additionally or alternatively be stored locally (e.g., on a resource), by a user device, and/or otherwise stored.

The recipes within the recipe database are preferably manually determined (e.g., defined by user, using a template, without a template, etc.), but can additionally or alternatively be automatically determined (e.g., recorded on a resource; extracted from media, such as a video, written recipe, or audio recording), determined from stored computer-readable media (e.g., as previously stored by user in the user database), or otherwise determined. The recipes within the database can be static, dynamic (e.g., updated based on recipe performance), or otherwise updated.

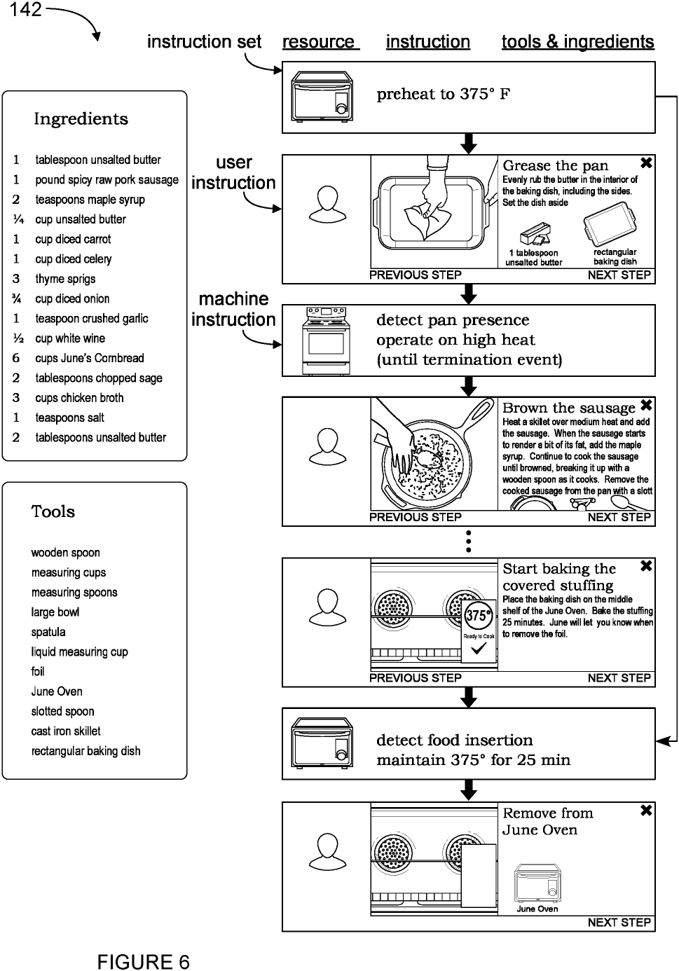

Each recipe within the recipe database can be associated with: a recipe identifier, a set of ingredients, a resource set (e.g., including a tool set, including a set of appliances, etc.), an instruction set, and/or any other suitable information (specific example shown in FIG. 6). The recipe identifier is preferably globally unique (within the recipe database), but can additionally or alternatively be non-unique, locally unique, human readable (e.g., identified by a title), and/or otherwise identified.

The set of ingredients can specify the ingredients (e.g., food precursors to be transformed) for the recipe. The set of ingredients can specify the ingredient type, the ingredient amount (e.g., numerosity, volume), whether the ingredient is required or optional, ingredient substitutes, auxiliary ingredient information, and/or any other suitable parameter. The set of ingredients can be: automatically determined (e.g., based on the ingredients associated with each step within the instruction set), manually determined (e.g., when the recipe is created), or otherwise determined.

The resource set can specify the resources needed for the recipe. The resource set can be defined by the recipe author (e.g., predetermined), automatically determined (e.g., adapted from original resource to available resources), and/or otherwise suitably determined. The recipe can be associated with a preferred set of resources, and can optionally include resource alternatives and/or alternative resource sets (e.g., when preferred resources are unavailable). In variants, there can be one or more resource sets per recipe, where each is associated with a different set of resources, a different instruction set, the same instruction set, and/or a modified instruction set (e.g., adapted from a base instruction set to employ the resources within the set). Alternatively, there can be only one resource set associated with a recipe. However, the recipe can be otherwise suitably associated with a resource set.

The instruction set functions to provide the series of steps to transform the ingredients into the final dish, using the resource and/or tool set. The instruction set preferably includes a series of steps (with dependencies), but can additionally or alternatively include any other suitable information.

Each step of the instruction set functions to specify a single transformation of the food precursor. Each step is preferably associated with: ingredient(s), tool(s), a resource (e.g., performing the step), resource instructions (e.g., for performing the step), and dependencies (to other steps), but can additionally or alternatively be associated with a step completion condition, step preconditions, and/or any other suitable component or data structure.

Each step is preferably associated with a single resource or resource type, but can additionally or alternatively be associated with multiple resources or resource types, resource alternatives (e.g., alternative resources that can be used for the same step), and/or any other suitable set of resources.

A step can optionally specify an inter-resource transfer (e.g., between two resources - such as a transition of foodstuff from one cooking appliance to another), which can include: which resource to transfer to, how to transfer the foodstuff between resources, or other details. The inter-resource transfer can be predetermined (e.g., defined by the recipe), automatically determined (e.g., based on the cooking schedule), or otherwise determined.

Each step can optionally include multiple instructions, such as different instructions for: different resources (e.g., alternative resources), different resource states, different foodstuff states (e.g., different starting food temperatures), different combinations of resources, or for other differing parameters. However, each step can otherwise suitably specify a transformation of the foodstuff.

The resource instructions of the step function to control resource operation, such that the resource can execute the step. Each step can include one or more resource instructions for the associated resources. When the step is associated with alternative resources, the step can include different resource instructions for each alternative resource, wherein the resource (and associated resource instructions) can be selected for inclusion in the cooking schedule based on the available resources and/or anticipated respective resource state. For example, the same step can include sous vide instructions and low temperature baking instructions, wherein the sous vide is selected when the recipe set includes high-temperature roasting recipes, and the sous vide is not selected when the recipe set includes only low-temperature roasting recipes.

The instruction set can include different types of resource instructions, based on the respective resource associated with the step. However, the instruction set can include the same type of resource instruction, wherein the resource instructions are translated to a resource-compatible format prior to instruction transmission to the resource. In variants, the instruction set can specify multiple (e.g., interchangeable) sets of control instructions for different resource selections (e.g., first set for oven, second set for a grill, and/or third set of sous vide, etc.).

Examples of resource instruction types can include: user instructions, machine instructions (e.g., target operation parameters, such as a target operating temperature, a target temperature profile, a target internal temperature of the foodstuff, etc.), media (e.g., text, audio, video, images, gifs, augmented reality, virtual reality, haptic feedback, etc.), and/or any other suitable instruction type (examples shown in FIG. 6). In a specific example, the resource instructions can be provided as the control instructions for a connected oven as described in U.S. Application Number 15/147,597, filed 05-MAY-2016, which is incorporated in its entirety by this reference.

User instructions can be included in a step when the respective resource is a user, but can additionally or alternatively include any other suitable resource instructions. User instructions can include: video, text, photos, graphics (e.g., on a web API), audio, images, gifs, augmented reality, virtual reality, haptic feedback, and/or any other suitable human-readable or human-consumable media. In variants, the user instructions can have different formats for different user display devices, wherein the processing system can automatically determine the display device type (e.g., web browser, mobile display, native application, etc.), select the associated user instruction format, and display the user instructions in the selected format. User instructions can include: illustrative examples of a precursor; illustrative examples of a step result or step product (which can be beneficial for scale or clarifying the meaning of imprecise cooking terminology); a dimension associated with a knife operation (knife skill), a thickness or nominal dimension of ‘dice’, ‘chop’, ‘slice’ and/or other imprecise term; an illustrative example of a tool/resource (e.g., an appropriate pan/bowl size, diameter, depth, etc.); and/or any other suitable information. However, steps can include any other suitable user instructions.

Machine instructions can be included in a step when the respective resource is a machine (e.g., connected appliance), but can additionally or alternatively include any other suitable resource instructions. Machine instructions can include: operation parameters, initiation conditions, termination conditions, and/or any other suitable instruction. Examples of operation parameters can include: resource operation modes or states (e.g., on/off state for the resource or one or more sub-components of the resource), power output targets, PID instructions, time, when a predetermined state or operation mode should be initiated or achieved (e.g., the required state of: a parent step, resource associated with a parent step, ingredient associated with a parent step, etc.), and/or any other suitable operation parameter. The machine instructions preferably include a timeseries of operation parameters, but can alternatively include a single operation parameter. The machine instructions can optionally include instruction subsets for substeps of the step, wherein each substep can be separated by an event or other transition condition. For example, the machine instructions can include preheat instructions (e.g., operate the heating elements at a threshold power output or above) and cook instructions (e.g., operate the heating elements at a percentage power output or operate the heating elements to maintain the cook cavity at a predetermined temperature), where the machine instructions can progress from the preheat instructions to the cook instructions in response to detection of a transition event (e.g., door open event, food-in-cavity detection event, food identification event, etc.).

Initiation conditions can include: a predetermined resource state (e.g., predetermined cavity temperature, preheated, predetermined contamination state, predetermined occupancy state, etc.), completion of parent steps (e.g., determined based on the step’s dependencies), the estimated completion time of the parent state(s) falling within a predetermined timeframe or range (e.g., estimated parent state completion within the next 10 minutes), availability of the resource associated with the step, detection of the correct foodstuff at the resource (e.g., as identified by a unique appliance identifier, from the food’s visual appearance, etc.), occurrence of a predetermined event, and/or other preconditions to determine whether the step can (and/or should) be initiated. All or portions of a given step can be initiated before or after completion of the step’s parent steps. The step precondition can be satisfied when the estimated or actual parameter value (e.g., time, sensor measurement, etc.) meets, surpasses, or otherwise satisfies the condition.

Termination conditions can include: sensor observation targets (e.g., target food internal temperature, target cooking cavity temperature, target humidity, etc.), timer expiration (e.g., time duration expiration), food or operation parameter target satisfaction (e.g., target internal temperature reached; visual parameter achieved, such as a predetermined amount of browning; etc.), satisfaction of multiple termination conditions (e.g., satisfied cooperatively/collectively by an internal temperature and degree of browning), and/or any other suitable step completion condition. The step completion condition can be satisfied when the estimated or actual parameter value (e.g., time, sensor measurement, etc.) meets, surpasses, or otherwise satisfies the condition.

The dependencies of the step function to specify the step relationships (e.g., performance order). The dependencies are preferably parent dependencies that specify the parent steps (e.g., steps that must be performed before the current step is performed), but can additionally or alternatively be child dependencies that specify the child steps (e.g., steps that must be performed after the current step is performed), and/or any other suitable dependency specifying any other suitable step relationship. Step dependencies within a recipe are preferably predetermined (e.g., by an author), but can additionally or alternately be determined automatically (e.g., during cooking schedule determination), determined contextually based on user preferences (e.g., target ‘doneness’, user specified internal temperature, completion condition, initiation condition, etc.), determined based on a user’s historical execution time or proficiency (e.g., wherein the step order can be adjusted based on deviant preparation time for specific user), and/or otherwise determined. Dependencies can include initiation conditions (pre-conditions) for a step and/or completion/termination conditions for a step. Initiation conditions can include: food detection, a determination that an appliance door is closed, a confirmation has been received from a user device, a determination that a food state satisfies a (target) precursor food state, a time prior to step completion (e.g., of a parent step or different step) has reached a predetermined time threshold - such as a preheat time, and/or any other suitable initiation conditions. Completion/termination conditions for a step can include: satisfaction of an internal temperature target, timer expiration (e.g., step duration expiration), sensor measurement surpassing a threshold (e.g., internal temperature meeting or surpassing a target temperature; food color falling within a target color range, etc.), satisfaction of an estimated parameter threshold (e.g., estimated based on cook time, appliance temperature, and/or cooking parameters; estimated internal food temperature based on visual appearance of food exterior; etc.), and/or any other suitable completion/termination conditions. Step dependencies can additionally include resource requirements – such as achievement of a required resource state – as part of an initiation condition (e.g., knife cleaned after a first use and before a subsequent use, oven preheated before cooking, etc.). Step dependencies can optionally include a notification condition, which can notify a user in response to a food state, a termination condition of another step (e.g., parent step), remaining time to completion (e.g., of current step, of a parent step, etc.), and/or any other suitable notification conditions.

Each step within an instruction set preferably includes at least one dependency, but can alternatively have no dependencies. For example, a baking step can be dependent upon a preheating step and a user-preformed step (e.g., placement of a baking dish into the oven). Each step is preferably dependent on the immediately preceding step, but can additionally or alternatively be dependent on the parents of the immediately preceding steps. For example, the baking step can additionally be dependent on the raw ingredient preparation steps preceding the user-performed step.

The step can optionally specify whether a dependency is optional or required. In this variation, the step can optionally include alternative resource instructions when a (optional) dependency is not satisfied. For example, the baking step’s heating curve and baking time can be modified (e.g., flattened and extended, respectively) when the oven was not preheated.

A step can optionally be associated with user notification parameters, which can function to specify whether, when, and/or how a user should be notified about the status of a current or upcoming step. For example, notification parameters can specify whether, when, and/or how a user should be notified about completion of an automatically-performed step (e.g., automatically performed by an appliance). This can be particularly useful for steps preceding user-performed steps, but can additionally or alternatively be included in other steps. User notification parameters can include: whether a user notification should be sent, the notification conditions (e.g., when a notification should be sent), the type of notification to be sent, the device that the notification should be presented on, and/or any other suitable parameter. The notifications can be predetermined, dynamically determined (e.g., based on a clock, based on the sensor observations, etc.), determined based on user preferences, determined based on user history (e.g., based on the user’s historical reaction time, based on the user’s historical step completion time, etc.), or otherwise determined. The notification can include: step instructions for a subsequent/upcoming step (e.g., where the user is the resource for said subsequent step), a notification that the step is complete, the estimated time of step completion (e.g., countdown timer, estimated clock time, etc.), a descriptor of the next step (e.g., of the next user-performed step, of the next step within the instruction set, etc.), food parameters (e.g., an image of the cooking food, a video of the cooking food, a graphic representative of the food, etc.), a temperature safety warning, an image and/or video stream of foodstuff within an appliance, an automatic translation of an instruction into a (predetermined) user-specified language and/or (predetermined) user-specified measurement system (e.g., metric units, English units; determined based on the available tools - such as measuring tools, etc.), and/or any other suitable information. The notification conditions can include: receipt of a user request for the notification, a current time satisfying a predetermined time, a current time until completion satisfying a predetermined time until completion, a sensor observation satisfying a predetermined value, step completion, and/or any other suitable condition. In a specific example, a notification can be sent to a user device in response to determination that the estimated time until the next step (e.g., estimated time until current step completion) is at least a predetermined amount of time. In this example, the estimated time until the next step can be determined based on: a timer for the step; historical estimates; the food’s current state, the food’s target state (for step transition), and the estimated rate of food state change (e.g., determined using a Kalman filter and sensor observations, etc.); determined using the method disclosed in U.S. App. No. 16/380,894 filed 10-APR-2019, incorporated herein in its entirety; and/or otherwise determined.

In a specific example, a user can be notified in response to a foodstuff parameter (e.g., visual food appearance captured by an optical sensor within an interior of the cooking appliance, internal temperature measured by a temperature probe, etc.) satisfying a target parameter as described in U.S. App. No. 15/147,597, filed 05-MAY-2016, which is incorporated in its entirety by this reference.

The notification types can include: push notifications, pull notifications, emails, calls, texts, audio alerts, and/or any other suitable notification. The notification can be presented by: a resource (e.g., the resource associated with the instantaneous step, a secondary resource, etc.), a user device, and/or any other suitable device.

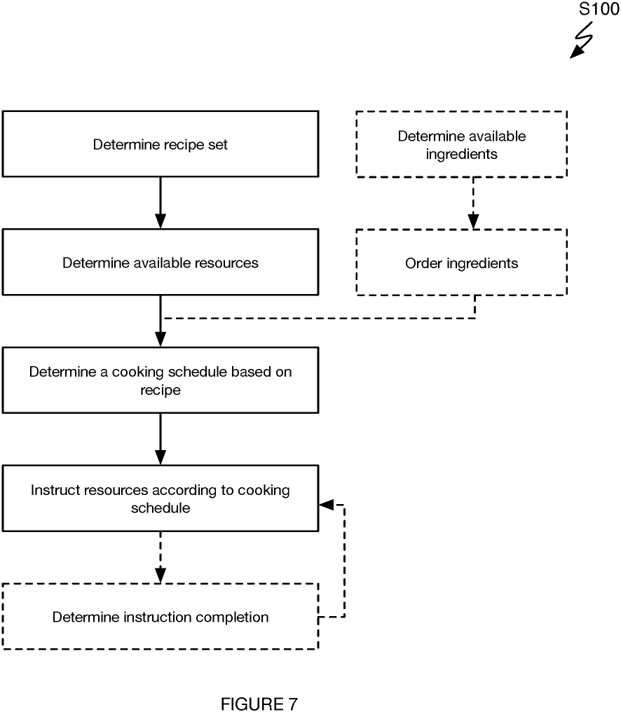

A recipe can optionally be associated with a set of auxiliary steps, which function to specify extra-recipe steps. The auxiliary steps can automatically be added to (and/or replace steps of): a recipe (e.g., instruction set), a cooking schedule, and/or any other suitable data structure. Examples of auxiliary steps can include: determining ingredient availability, obtaining ingredients (e.g., ordering groceries through a grocery API, as shown in FIG. 7, etc.), cleanup (e.g., for each resource, each tool, etc.), eating (e.g., at a predetermined and/or user specified meal time; defining a specific course duration), an appliance transition delay (e.g., which can be predefined, learned, etc.), a resting delay (e.g., cooling before eating, meat resting before cutting meat, etc.), and/or any other suitable auxiliary steps. In a first example, plating a completed meal or a dish therein can be a terminal step (dependent on every step in the recipe, child of every step in every recipe, etc.). In a second example, a transition delay between a first and a second appliance can be determined based on historical delay between food exiting a first appliance to arrival at a second appliance, and can be added as an auxiliary step or accounted for when determining the initiation or termination conditions of the successive or preceding step, respectively.

A cooking schedule 146 can provide instructions for contemporaneously preparing multiple recipes 142 of a menu 144. The cooking schedule preferably includes a set of recipes from the recipe database (e.g., user selected, etc.) which can be implemented serially, in parallel, or composited to create a meal. The cooking schedule includes the set of recipe steps (e.g., from each of the set of recipes), each with a set of (intra-recipe) dependencies. The cooking schedule can optionally include inter-recipe dependencies, which functions to streamline simultaneous execution of multiple recipes.

Assigning inter-recipe dependencies can satisfy a meal plan objective to minimize a span of completion times for the set of recipes (e.g., a recipe can be considered complete when it is ‘ready to eat’, plated, after a predetermined resting period, etc.), where the span of completion times is the time difference between the completion time of the first completed recipe and the last completed recipe. Preferably, the span between completion times is on the order of minutes and/or is minimized within a threshold time window (e.g., 5 minutes, 10 minutes, etc.). However, the span between completion times alternately not be minimized, and/or the cooking schedule objective can target a periodic completion rate (e.g., associated with multiple courses), and/or be otherwise suitably implemented. Additionally or alternatively, the cooking schedule objectives can target a minimization of the total cooking duration, taken as the time between start of cooking and completion of the final recipe, and/or target any other suitable meal plan goals. The meal plan goals can be: automatically determined, manually determined, determined from user preferences or user history, or otherwise determined. In a specific example, the meal plan goals can account for user history when planning, and can consider a historical time to: chop, complete various steps, get out ingredients, transfer foodstuff precursors, interpret instructions, transition between indoor and outdoor appliances (as can be unique to a specific user in their cooking environment), and/or other suitable historical timing data.

Inter-recipe dependencies can be child dependencies, parent dependencies, synchronous dependency (e.g., for simultaneous/parallel cooking processes—such as beginning two baking steps at the same start time), and/or any other suitable dependencies. In variants, for synchronous dependency, the machine instructions of a first recipe can be modified to conform to a second recipe (e.g., synchronous baking with a different oven temperature). Machine instructions can be modified dynamically and/or in real time, but can alternately be predetermined (e.g., modify a cooking curve, add time dependency or delay until satisfaction of a dependency condition, etc.). Inter-recipe dependencies can be determined based on the meal plan objectives, resource requirements (e.g., required resource temperature for successive steps), resource commonalities (e.g., same resource, same resource state, resource space availability, etc.), and/or other parameters. Inter-recipe dependencies can be determined using a combinatorial optimization, Gantt chart optimization, heuristics (e.g., metaheuristics), schedule optimization, stochastic optimization, genetic algorithms, coordinate descent, simulated annealing, manually determined, and/or other suitable techniques.

Additionally or alternately, inter-recipe dependencies can include auxiliary steps (e.g., transitioning between appliances, cleaning resources, etc.) and/or optional recipe dependencies.

However, inter-recipe dependencies can be otherwise suitably implemented.

A user device functions to display user instructions, display user notifications, receive user selections (e.g., of the menu, of the recipes, etc.), receive resource information (e.g., available resource types, available resource numbers, available resource capabilities, etc.), receive tool information (e.g., types, numbers, capabilities, etc.), and/or perform any other suitable functionality. Examples of user devices that can be used include smartphones, smart speakers (e.g., connected speakers), user interfaces on the resources (e.g., touchscreens, knobs, dials, etc.), laptops, and/or any other suitable device. The system can interact with one or more user devices.

The processing system can include a user database which functions to store user data. User data can include: user preferences, user history (e.g., historical recipes, step completion time, transfer time, responsiveness, settings, preferences, etc.), associated resources, or other information. User data can be: manually entered, learned, recorded, or otherwise determined. User history can be used to determine: user preferences, providing recipe suggestions, establishing dependencies (e.g., inter-recipe, intra-recipe), and/or otherwise used. Historical user data can include: previously utilized/determined resources (e.g., number of knives, set of appliances, size of pans/skillets/bowls, volume of pots, etc.), previous user preferences (e.g., browning preference; internal temperature preferences; ‘doneness’ preferences for a meat type, cut, thickness, etc.; food restrictions such as dietary restrictions, allergies, allergy severity, etc.; food preferences such as cuisine, vegetable type, meat type, taste profile, texture profile, seasoning preferences, etc.; measurement unit preference; language preference; etc.), historical execution data, and/or any other suitable data. Historical execution data can include a historical step execution time, taken as the difference (and/or ratio) between the expected step duration and the actual duration, which can be used to calculate a user skill factor or user adjustment for various steps (e.g., for median/avg user – 1x time multiplier; for slower user – 1.5x time multiplier; for faster/experienced user – 0.75x time multiplier; etc.). Historical execution data can also determine a time delay between successive steps – such as a historical time required to transport a precursor from an indoor appliance (e.g., oven) to an outdoor appliance (e.g., grill). Historical execution data can be accounted for in future recipe determination and/or inter-recipe dependencies, such as when calculating a use-specific cooking duration and/or user-specific recipe combination. Additionally, historical execution data can include stored images and/or food classification from historic use of the appliance, which can be used to improve recipe recommendations (e.g., based on user habits/preferences). The user database can be included and/or stored within the user device, processing system, and/or other suitable endpoint. However, the system can include any other suitable user database.

The system can include one or more instances of one or more processing modules, which functions to execute all or a portion of the method. For example, the system can include: a planning module, a tracking module, a grocery module 124, and/or other modules. The planning module functions to generate composite (interdependent) menu steps from recipe steps. The tracking module functions to track food progress (e.g., per step, per appliance, for the menu, etc.). The grocery module 124 functions to order ingredients for a recipe (and/or menu). However, the system can include any other suitable set of processing modules.

However, the system can include any other suitable components.

### 4 Method

As shown in FIG. 1, the cooking coordination method includes: determining a menu S110; determining available resources S120; determining a cooking schedule based on the menu S130; and instructing the resources according to the cooking schedule S140. The method can optionally include: monitoring cooking progress S150; and determining step completion S160. The method functions to automatically coordinate a set of resources to cooperatively cook a menu (e.g., recipe set). In variants, the method functions to automatically coordinate the set of resources such that cooking is completed at the same time. However, the method can include any other suitable elements.

Determining a menu S110 functions to identify the recipe set to be cooked by a resource set. The menu includes a recipe set, which can be determined: automatically (e.g., based on historical recipe sets, user preferences, a calendar, etc.), manually (e.g., received from a user, customer, chef, author, etc.), or otherwise determined. A single recipe set is preferably received for a resource set for a given cooking timeframe, but multiple recipe sets can alternatively be received (e.g., at different times, after cooking schedule execution has been initiated, etc.). The recipe set can be determined: a recipe at a time, as a batch (e.g., wherein a predetermined menu, including a set of recipes, is selected), or otherwise determined. The recipe set can be predetermined or determined: in response to receipt of recipe selection, at predetermined frequency (e.g., once a day, once a week), in response to receipt of a user request or acceptance, upon occurrence of a planning event (e.g., user arrival at home, proximity to a predetermined date, etc.), or at any other suitable time.

The recipe set (menu) preferably includes one or more recipes, but can additionally or alternatively include any other suitable number of recipes. The recipe set preferably includes recipe identifiers for recipes within the recipe database, but can additionally or alternatively include identifiers for recipes outside of the recipe database (e.g., a recipe URL) and/or any other suitable recipe.

In a first example, the menu can be determined individually for a single meal (e.g., dinner). In a second example, the menu can be determined in conjunction with a set of meals (menus) spanning a predetermined duration (e.g., week). In the second example, the menu(s) can be selected to include recipes which share common ingredients, have common characteristics (e.g., satisfying a diet plan), have distinct characteristics (e.g., exceeding a minimum threshold of protein types, exceeding a minimum threshold of cuisine or country of origin types), and/or be otherwise determined. In the second example, the menu can identify common ingredients (e.g., spices; grain/seeds common between meals, such as rice or quinoa; etc.), and combine the total quantity when determining ingredient availability and/or for ingredient ordering purposes. However, the menu can be otherwise suitably determined.

Determining available resources S120 functions to determine the resources that can be used to cook the recipe set. Determining the available resources can include determining resource information such as: the resource types, number of resources, resource capabilities, resource identifier (e.g., networking address, model number), resource state (e.g., on/off, temperature, etc.), resource parameter values, and/or any other suitable resource data. The available resource information can be determined: periodically, in response to occurrence of a resource determination event, once (e.g., upon resource determination event occurrence, upon initial user setup, etc.), before recipe set determination, at a predetermined frequency (e.g., throughout the cooking session), and/or at any other suitable time. Examples of resource determination events include: recipe set determination or receipt; appliance initiation; systemassociated client launch (e.g., when the user opens a native application on a user device); and/or at any other suitable time.

The available resource information can be determined by: the user (e.g., manually), the processing system (e.g., automatically - such as by pulling a resource state; determining which appliances/devices are currently registered, signed-in, or powered; requesting measurements from the appliances; etc.), or otherwise determined. Available resource information can be stored at the user database (e.g., at a user device, at the control system), at the resource database, and/or otherwise stored. In a first variation, the user enters the resource information (e.g., checks off a checklist automatically generated by aggregating the resources from the recipes within the recipe set; types in or selects the resource information; etc.). For example, the user can enter the make and model of available resources (e.g., oven, sous vide, stove, etc.), any resource limitations, the number of people available, the skill level for each person, and/or any other suitable resource information. In a second variation, the processing system retrieves predetermined resource information associated with the user from a user database. In a third variation, the processing system automatically queries the resources associated with the user to determine the resource information (e.g., availability, state, etc.) via a network associated with the user (e.g., a LAN) or resource (e.g., each resource’s remote computing system). However, the resource information can be otherwise determined.

Available resource information can optionally include available tool information, which functions to determine the tools that can be used to cook the recipe set. Alternatively, the method can not determine the available tool information, and assume that the user has access to the requisite tools. Determining the available tool information can include determining: the tool types, number of tools, tool capabilities, tool identifier (e.g., address, model number), tool state (e.g., clean / contaminated, etc.), and/or any other suitable tool data. The available tool information can be determined: once (e.g., upon initial user setup), at cooking schedule execution initiation, and/or at any other suitable time. The available tool information can be determined by: the user, the processing system (e.g., automatically), or otherwise determined. For example, the user enters the tool information (e.g., checks off a checklist or confirming a list automatically generated by aggregating the tools from the recipes within the recipe set; types in or selects the tool information; etc.). However, the available tool information can be otherwise determined.

The method can optionally include determining available ingredient information, which functions to determine the ingredients used to cook the recipe set. Alternatively, the method can not determine the available ingredient information, and assume that the user has access to the requisite ingredients. Determining the available ingredient information can include determining: the ingredient types, number of ingredients, and/or any other suitable ingredient data. The available ingredient information can be determined: after the recipe set is determined, at cooking schedule execution initiation, a predetermined duration before cooking schedule execution initiation (e.g., at least the delivery time, etc.), and/or at any other suitable time.

The available ingredient information can be determined by: the user, the processing system (e.g., automatically, such as from a grocery API or a smart refrigerator), or otherwise determined. In a first example, the user enters the ingredient information (e.g., checks off a checklist or confirming a list automatically generated by aggregating the ingredients from the recipes within the recipe set; types in or selects the ingredient information; etc.). In a second example, the processing system queries an ingredient storage system (e.g., a connected refrigerator) for the ingredient information. In a third example, the processing system automatically orders groceries based on the ingredients for the recipe (recipe ingredients). In this example, the processing system can construct a query for the recipe ingredients (e.g., for all recipe ingredients, ingredients for multiple recipe sets, ingredients missing from the user’s stock, etc.), and transmit the query to a grocery API (e.g., Safeway™ API). In this example, the system can optionally convert recipe ingredient units (e.g., grams, “a pinch”) to grocery units (e.g., number of medium onions). However, the processing system can otherwise interact with a grocery API. In variants where the processing system determines the available ingredient information, the processing system can optionally: determine ingredient alternatives for one or more recipe ingredients (e.g., based on the recipe, based on user preferences, based on a predetermined replacement chart, etc.), determine that the user does not have a recipe ingredient, determine that the user has an ingredient alternative, and automatically adjust the recipe (e.g., instruction steps, ingredient lists, etc.) to accommodate the ingredient alternative.

However, the available ingredient information can be otherwise determined.

Determining a cooking schedule based on the menu S130 functions to generate a unified workflow for the resources to cooperatively cook the recipe set of the menu. The cooking schedule is preferably determined by the processing system, but can additionally or alternatively be determined by a resource or any other suitable system. The cooking schedule can be determined: once (e.g., for a recipe set), iteratively, or any other suitable number of times. The cooking schedule can be determined: upon recipe set determination, when a recipe is added to the recipe set (e.g., re-determined if the cooking schedule is partway executed), in response to receipt of a user request to generate the cooking schedule, within a threshold time period of a user-specified meal time (e.g., within a time window offset before the user-specified meal time by the duration of the cooking schedule), and/or at any other suitable time.

The cooking schedule is preferably determined based on the recipes within the recipe set, more preferably based on the instruction set associated with each recipe within the recipe set, but can additionally or alternatively be determined based on: the available resources, the available tools, the available ingredients, a standard set of instructions, and/or based on any other suitable information. The cooking schedule can optionally be determined based on the user cooking history (e.g., historical execution data), and can adjust the expected duration of various steps (and/or duration between steps) based on a skill factor, fixed offset, historical time, or other user parameter.

The cooking schedule preferably includes a series of (dependent) tasks for each of the available resources (e.g., cooking appliances and/or tools). Examples of the cooking schedule can include: Gantt charts, dependency graphs, directed acyclic graphs (e.g., wherein the nodes represent steps and duration, and the transitions represent dependencies; etc.), dependency trees, critical path network diagrams, and/or any other suitable data structure. The cooking schedule preferably preserves the dependencies of the constituent (intra-recipe) instruction sets, but can be otherwise constructed. The cooking schedule is preferably determined according to a set of predetermined rules, heuristics, or goals, but can be otherwise determined. Examples of rules or heuristics can include: batching user instructions together temporally, based on common tools, based on tool state, or based on another parameter; cooking lower-temperature recipes before higher-temperature recipes; selecting an alternative resource when a recipe calls for extended use of a resource that is in high demand by other recipes; and/or any other suitable rule. Examples of goals can include: finishing the recipes at the same time, within a predetermined time window (e.g., within a predetermined time of each other, within a predetermined time from recipe addition to the recipe set, etc.), or any other suitable goal.

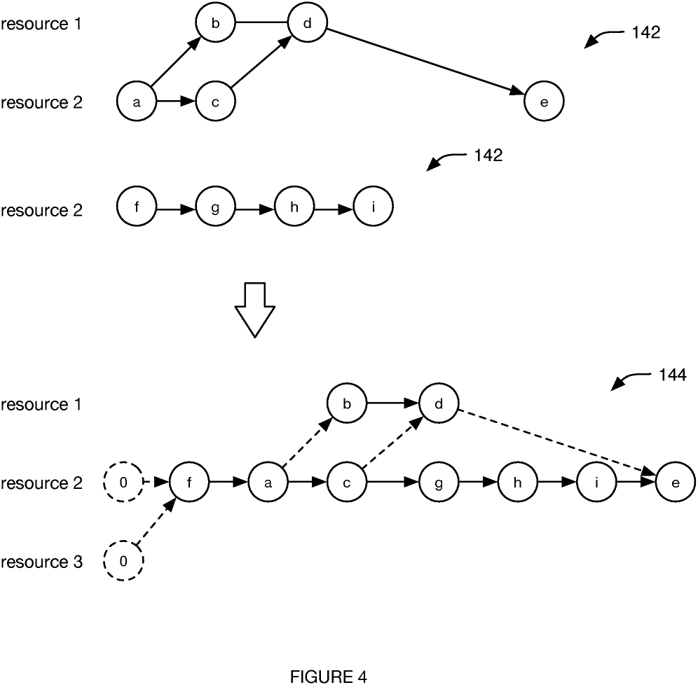

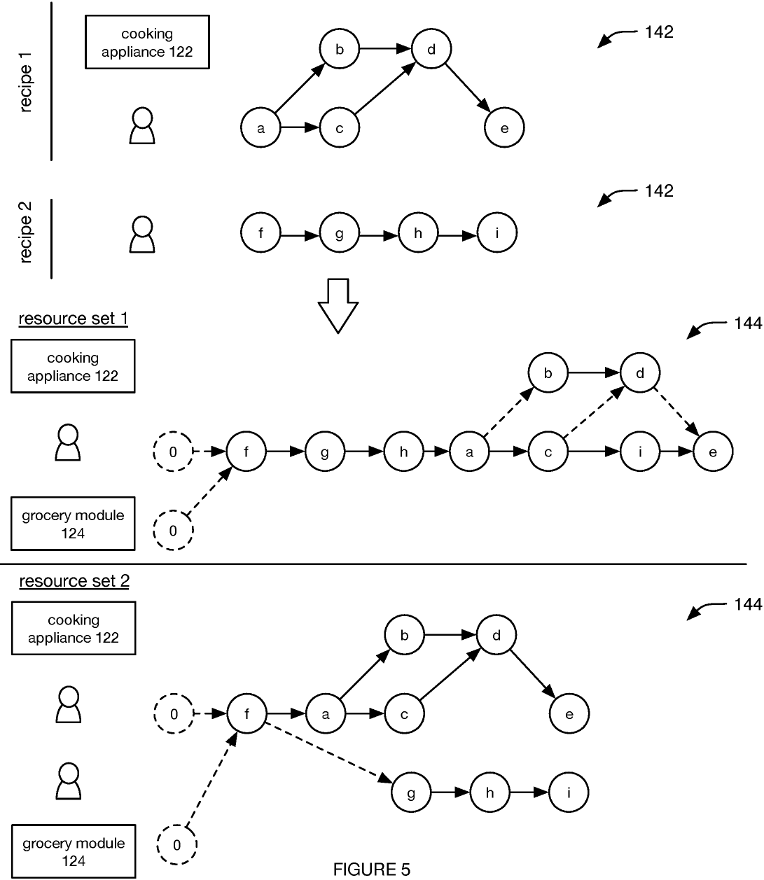

Determining the cooking schedule preferably includes merging the instruction sets and assigning tasks to different resources and/or tools (specific examples shown in FIG. 4 and FIG. 5), according to a set of inter-recipe dependencies. Inter-recipe dependencies can be determined using a: combinatorial optimization, Gantt chart optimization, heuristics (e.g., metaheuristics), schedule optimization, stochastic optimization, genetic algorithms, coordinate descent, simulated annealing, and/or other suitable techniques. In a first variation, the cooking schedule is merged by: generating an optimized cooking schedule (e.g., by optimizing for one or more goals, such as concurrent completion time, batched resource use, etc.). In a second variation, the cooking schedule is merged by: generating a set of candidate cooking schedules (e.g., based on a predetermined algorithm, randomly, etc.), scoring each candidate cooking schedule (e.g., according to the rules, goals, etc.), and selecting the best (e.g., highest) scoring candidate cooking schedule. In a third variation, the cooking schedule is merged by: converting the instruction sets to adjacency lists and sorting the adjacency list by dependencies. In a fourth variation, the cooking schedule is merged by topologically sorting the instruction sets (e.g., using Kahn’s algorithm, depth first search, parallel algorithms, etc.). However, the cooking schedule can be otherwise merged.

Merging the instruction sets can optionally resolve conflicts, such as resource availability conflicts, by optimizing step performance order, but can resolve conflicts in any other suitable manner. Merging the instruction sets can optionally merge common steps across the instruction sets (e.g., merges or appends chopping steps, etc.) based on: resource, tool, ingredient, and/or any other suitable parameter. For example, a common step across instructions (e.g., chopping) can be merged into a single step, wherein the number and type of ingredients can be summed. Additionally or alternatively, the common steps can be merged based on the number of resources, required by the step, that are available. For example, the common step can be merged when there is a single resource available (e.g., chopping is merged into a single step when a single user is available), but can be maintained as separate (and assigned to different resources) when multiple resources are available (e.g., chopping is not merged when multiple users are available (specific example shown in FIG. 5).

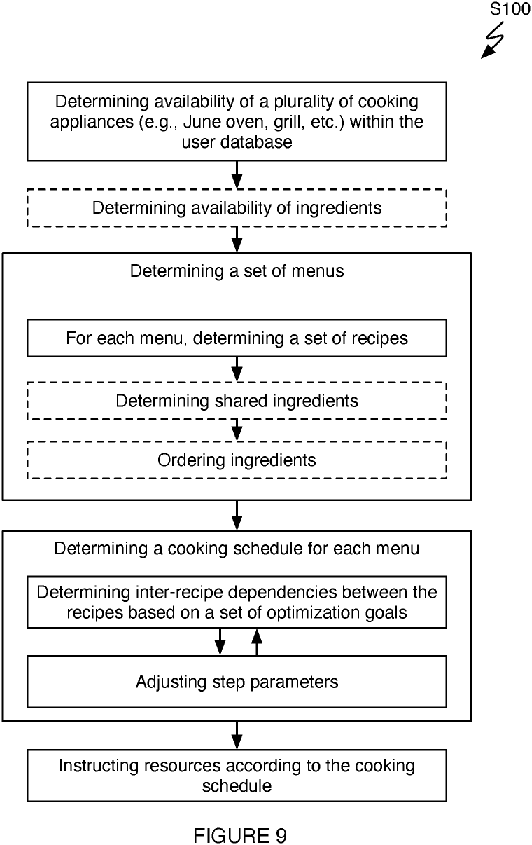

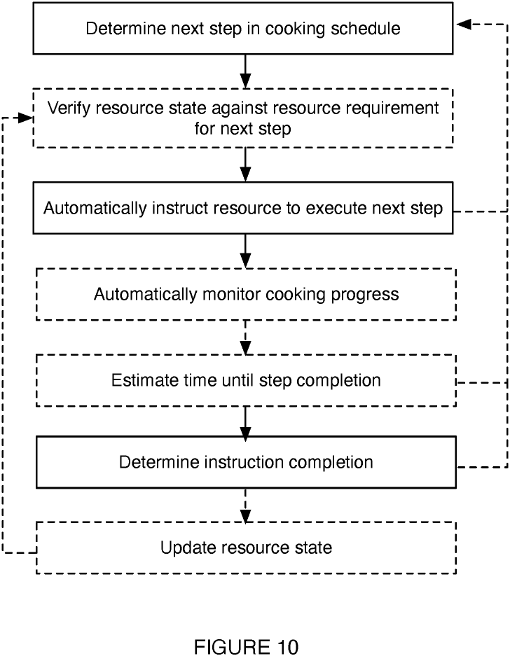

Determining the cooking schedule can optionally include adjusting step parameters (e.g., before execution, during operation; an example is shown in FIG. 9). In a first variant, adjusting step parameters can be based on user preferences (e.g., total calorie count). In a second variant, adjusting step parameters can be based on delays or deviations from an expected progress (e.g., adjust step order based on delay from a prior step, adjust cooking temperature to accelerate cooking, etc.). However, step parameters can be otherwise suitably adjusted as a part of determining the cooking schedule.

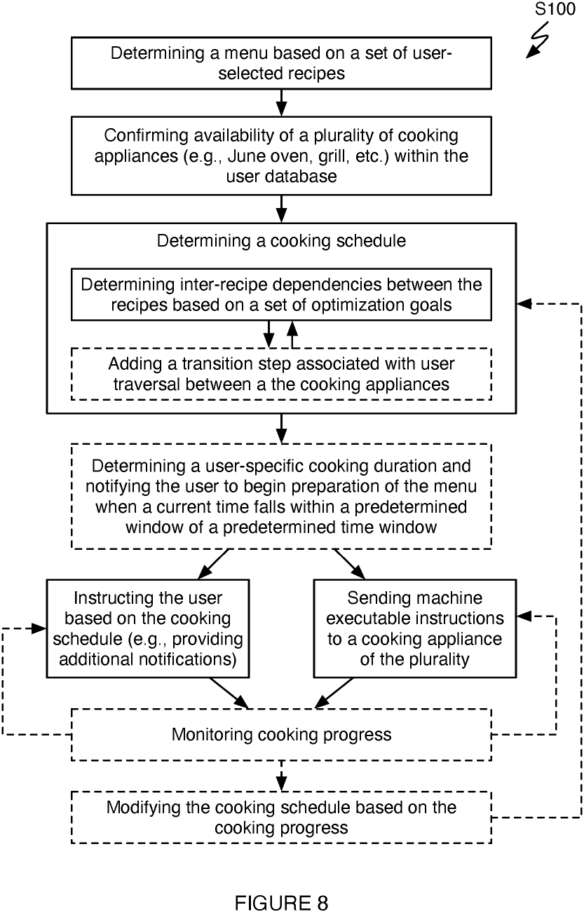

Determining the cooking schedule can optionally include adding additional steps. The additional steps are preferably not included in a recipe, but can additionally or alternatively be included in a recipe. The additional steps can include dependencies to one or more step types (e.g., generic step types, wherein the steps within each instruction set is associated with a step type), but can additionally or alternatively include no dependencies, include dependencies to a specific step, and/or include any other suitable type of dependency. Examples of additional steps that can be added include: additional preparation steps (e.g., obtaining groceries), additional cleanup steps (e.g., based on the prior and/or subsequent tool or resource state), transition steps (e.g., accounting for the transition time required for a user to traverse between an indoor appliance and an outdoor appliance; an example is shown in FIG. 8), and/or any other suitable step. The additional steps can be added: at the beginning of the cooking schedule, between steps of the cooking schedule (e.g., cleaning the only knife between preparing a chicken and chopping vegetables for a salad), at the end of the cooking schedule, and/or at any other suitable point in the cooking schedule. The additional steps are preferably added after the cooking schedule is determined, but can additionally or alternatively be included in the unified instruction set (to be merged) or at any other suitable time. The additional steps are preferably added by the processing system, but can additionally or alternatively be added by the user or any other suitable component.

Instructing the resources according to the cooking schedule S140 functions to automatically control the resources to perform the assigned tasks. The resources are preferably instructed by the processing system, but can additionally or alternatively be instructed by a resource or any other suitable component. The resources are preferably instructed according to the cooking schedule (e.g., based on the tasks assigned to the respective resource within the cooking schedule), but can additionally or alternatively be instructed based on any other suitable data. Instructing the resources preferably includes transmitting the resource instructions (and optionally, the start or stop conditions per resource instruction) to the respective resource, but the resources can be otherwise instructed. The instructions can be sent: directly to the resource (e.g., via a LAN, via an API connected to the resource, etc.), indirectly to the resource (e.g., to a gateway or routing system that forwards the instructions to the resource), and/or otherwise sent. The instructions can be sent using a push configuration (e.g., initiated at instruction-transmitting end), pull configuration (e.g., initiated at instruction-receiving end), and/or other suitable configuration. The instructions can be sent: as a batch (e.g., before the cooking session, at the beginning of the cooking session), individually (e.g., upon determination of prior step completion for the respective resource; upon determination that the prior step for the respective resource will be completed within a predetermined time window, etc.); in response to receipt of an instruction request from the resource (e.g., in response to a “next step” icon selection by the user; in response to a next step request from an appliance, automatically generated by the resource upon resource instruction completion; in a pull configuration; etc.); in response to satisfaction of an initiation condition; in response to completion of all parent step(s); in response to detection of foodstuff presence at the food resource associated with the step; and/or in any other suitable grouping.

In an example, an initiation condition of a step can be satisfied by a verification that the foodstuff detected at the step’s resource matches the product of a prior (parent) step. In a specific example, the initiation condition can include: sampling an image of the foodstuff at the resource associated with the step (e.g., in response to a door open or close event); identifying the foodstuff (e.g., using a classification model, reading an identifier on an accessory shared between steps, etc.); and determining whether the determined food identifier matches the expected food identifier (e.g., wherein the expected food identifier can be associated with the step, determined by a resource associated with the prior step, etc.).

In a second example, an initiation condition of a step can be satisfied when the estimated completion time (or time to completion) of the prior step falls within a predetermined timeframe (e.g., a preheating timeframe). In a specific example, the processing system can estimate the parent step’s completion time (e.g., based on sensor data sent to the processing system by the parent step’s resource, such as temperature probe data or images), and automatically control the resource for the child step to initiate the respective control instructions when the parent step’s completion time falls within a predetermined timeframe (e.g., within 2 minutes, 5 minutes, etc.). The estimated completion time can be determined using the methods disclosed in U.S. App. No. 16/793,309 filed 18-Feb-2020, U.S. App. No. 16/380,894 filed 10-Apr-2019, and US Application Number 17/100,046, filed 20-NOV-2020 and titled “SYSTEM AND METHOD FOR ESTIMATING FOODSTUFF COMPLETION TIME”, each of which is incorporated herein in its entirety by this reference, or otherwise determined. However, the initiation condition can be otherwise satisfied.

Instructing the resources according to the cooking schedule S140 can include executing machine instructions at the resource (e.g., where the resource is a cooking appliance) which functions to perform the cooking instruction. Executing machine instructions can include: controlling a heating element, sampling a temperature of the appliance (e.g., closed loop control, feedback control), sampling a temperature of the foodstuff precursor, capturing images of an appliance interior with an optical sensor, and/or otherwise suitably executing machine instructions. In variants, executing machine instructions can include transmitting the temperature (e.g., of the appliance and/or foodstuff) and/or images to the control system, which can be used for execution of the method (e.g., step progress monitoring, step cessation, next step initiation, etc.) and/or stored for determination of user preferences. In variants, executing machine instructions can optionally include adjusting and/or dynamically modifying based on the temperature and/or images.

In variants where the user is the resource executing the instructions, instructing the resources can include determining the user instructions for the respective step and transmitting the user instructions to the user device. Determining the user instructions can include: identifying the instruction set for the respective step, optionally selecting instructions (e.g., content) compatible with a user device format or user preference from the instruction set, optionally include translating language instructions into a preferred language of origin and/or selecting a set of predetermined instructions based on a language preference, and/or otherwise determining the user instructions. The user instructions can be sent directly from the processing system, via a resource, or otherwise transmitted to the user device.

In variants, instructing the resources can include changing an actual resource state (e.g., to a predetermined state associated with step execution; update the state with a parameter value; etc.).

However, resources can be otherwise suitably instructed.

Monitoring cooking progress S150 functions to determine information associated with a food state, which can be used to determine step completion (or an estimated step completion parameter) and/or notify a user. The cooking progress can be: binary (e.g., unfinished / finished), continuous (e.g., arbitrary values of a cook score, measurement value, etc.), one of multiple classes (e.g., raw, rare, medium rare, medium, done, well done; within one of a predetermined number of temperature bins; within one of a predetermined set of completion classes; etc.), or otherwise characterized. The cooking progress can be determined based on a sensor measurement value, a score (e.g., calculated from the sensor measurement values), a description, a class, or any other suitable metric.

In a first variant, the cooking progress can be monitored based on sensor feedback (e.g., visual, temperature change, using an auxiliary temperature probe). In a second variant, the cooking progress can be monitored using a timer. In a third variant, the cooking progress can be manually monitored, wherein the user enters the food state in a user application. In a fourth variant, the food state is inferred (e.g., from performance or initiation of subsequent steps, from a user marking a step as “done”, etc.). Monitoring cooking progress can optionally include estimating step completion -which can estimate a time to completion, a food state at completion, a resource state at completion, and/or any other suitable estimation. Estimating step completion can include using a lookup table, an equation (e.g., polynomial estimation function, smooth curve, piecewise smooth curve, etc.), a neural network, and/or any other suitable techniques. However, the method can otherwise suitably monitor the cooking progress.

Determining step completion S160 functions to determine whether a step within the cooking schedule has been completed. Step completion can be determined by: a user (e.g., manually; in the form of a user input to a user device; etc.), the resource completing the step, the processing system (e.g., wherein resource states and/or sensor observations are transmitted to the processing system, example shown in FIG. 3), an auxiliary system (e.g., secondary resource monitoring the resource performing the step), and/or any other suitable component. Step completion can be determined based on: a set of sensor observations (e.g., sampled by the resource, sampled by a tool associated with the resource) satisfying a predetermined set of sensor values (e.g., predetermined internal temperature, etc.); instruction completion notification receipt; satisfaction of a predetermined completion condition (e.g., such as a change in a resource state); and/or otherwise determined. For example, a prior step can be marked as complete when a cooking appliance detects food insertion into its cooking cavity (e.g., based on images sampled by an on-board camera, cooking appliance weight change, cooking appliance door or lid opening; as described in U.S. App. No. 15/147,597, filed 05-MAY-2016, which is incorporated in its entirety by this reference; etc.). In a second example, a current step can be marked as complete when an internal temperature of the food (e.g., measured by a temperature probe) meets a predetermined temperature. In a third example, a current step can be marked as complete when an optical parameter of foodstuff meets a predetermined color threshold (e.g., as monitored by a camera of the cooking appliance). In variants, determination of instruction completion can trigger initiation of a child step and/or a step having an initiation condition which is satisfied by the determination of instruction completion.

However, the method S100 can include any other suitable elements.

### 5 Examples

In a first example, the set of resources includes two users, the cooking schedule includes two recipes, and the two users receive exclusive instruction sets (e.g., the manual steps are split between the two users). The instructions sets can include co-dependent instructions, such as wherein: a first instruction of the first user is a parent (directly or indirectly) to a first child instruction of the second user, and/or a second instruction of the second user is a parent (directly or indirectly) to a second child instruction of the first user. In a specific example, the system can dynamically redistribute instructions between the users based on their relative progress with their respective instruction sets. In a second specific example, each user is uniquely identified by and receives instructions at a respective user device (e.g., with a device identifier).

In a second example, the cooking schedule includes two recipes and the set of resources includes two cooking appliances. In response to automatically determining completion of a first instruction at the first cooking appliance, a second instruction is provided to the user, wherein the second instruction is associated with a cooking resource of the set which is associated with the second appliance. In a specific example, the completion of the first instruction at the first cooking appliance is determined based on a detection of foodstuff using an optical sensor of the first cooking appliance.

In a third example, the cooking schedule includes two recipes and at least one cooking appliance. The meal plan includes a first and second recipe associated with a first and second foodstuff precursor, respectively, and the meal plan includes a composite step combining a first step of the first recipe with a second step of the second recipe. In a first example, the composite step has the combination of dependencies of the first and second steps. In a second example, the first step inherits the dependencies of the second step, and the second step inherits the dependencies of the first step.

In a fourth example, the method can include: determine a plurality of recipes, combining the steps of the plurality of recipes (e.g., using a combinatorial optimization to order the steps based on an optimization goal); ordering groceries (e.g., at time estimated to result in “just-in-time” delivery, for all the recipes of the plurality, etc.); sending instructions to user to prep the plurality of recipes (e.g., with video instructions, etc.); instructing the user to put (prepped) food precursors into a first cooking appliance; starting execution of a first instruction set (e.g., automatically) in response to food verification (e.g., automatic food verification) based on appearance (e.g., determined from an image) at the first cooking appliance; periodically sampling food measurements (e.g., internal temperature); estimating a time to step completion based on the food measurements; when estimated time to step completion falls within a predetermined range, automatically starting execution of a second instruction set at a second appliance (e.g., associated with the next step). The example can include optionally notifying the user when the first step is completed, directing the user to transfer food to the second appliance (e.g., after a second condition for the first step is satisfied, such as when the step is completed). The example can optionally cease first appliance operation and automatically continue executing second instruction set (e.g., second subset of instructions) in response to detection of the food at the second appliance (e.g., based on food appearance, weight, etc.). The food appearance can be verified when the detected food class matches the expected food class, when the food’s appearance (determined by the second appliance) substantially matches the food appearance determined by the first appearance prior to food removal (e.g., within a predetermined range of error), and/or can be otherwise verified.

An alternative embodiment preferably implements the above methods in a computer-readable medium storing computer-readable instructions. The instructions are preferably executed by computer-executable components preferably integrated with a cooking coordination system. The cooking coordination system can include: a recipe database, a user preferences database, a cook scheduling system, one or more user interfaces, and/or any other suitable module. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method comprising:
determining a set of cooking resources;
determining a plurality of recipes, each recipe comprising cooking instructions and a set of intra-recipe dependencies specifying an intra-recipe order the cooking instructions;
determining a cooking schedule that minimizes a span between completion times of each of the plurality of recipes, wherein the cooking schedule comprises inter-recipe dependencies between cooking instructions of different recipes while preserving intra-recipe dependencies of each recipe; and
instructing the cooking resources according to the cooking schedule, comprising:
controlling a first cooking resource based on a first cooking instruction of the cooking schedule; and
automatically providing a secondary cooking instruction to a second cooking resource, separate from the first cooking resource, wherein the secondary cooking instruction execution is dependent on completion of the first cooking instruction.

2. The method of claim 1, wherein determining the cooking schedule for the plurality of recipes comprises determining the inter-recipe dependencies based on historical data associated with a user.

3. The method of claim 1, wherein determining a cooking schedule for the plurality of recipes comprises modifying the instructions, comprising:
determining concurrent execution of a first and a second cooking instruction at a first resource, the first and second instructions associated with a first and second recipe, respectively; and
creating a new instruction based on the first and second cooking instructions.

4. The method of claim 3, wherein the instructions are modified based on the set of cooking resources.

5. The method of claim 1, wherein completion of the first cooking instruction is determined by recognizing a first and second food associated with the first and secondary cooking instructions, respectively.

6. The method of claim 1, wherein determining the cooking schedule for the plurality of recipes comprises: determining inter-recipe dependencies according to a combinatorial optimization of an expected duration of each instruction and the set of resources.

7. The method of claim 1, wherein the cooking schedule is determined based on a historical transition time associated with food transition between the first cooking resource and the second cooking resource.

8. The method of claim 1, wherein the first cooking resource comprises a connected appliance.

9. The method of claim 8, wherein the first cooking resource is a connected oven, wherein the second cooking resource is a connected grill.

10. The method of claim 8, further comprising: monitoring food cooking progress based on sensor measurements sampled by the first cooking appliance; wherein the secondary cooking instructions are automatically provided in response to the food cooking progress satisfying a predetermined initiation condition associated with the secondary cooking instructions.

11. The method of claim 1, further comprising: in response to an elapsed execution time of an instruction falling within a threshold of an expected instruction duration, automatically notifying the user of a start time of a subsequent instruction.

12. The method of claim 11, further comprising: determining the expected instruction duration of the instruction based on historical execution data.

13. The method of claim 1, further comprising: modifying a recipe of the set of recipes based on a historical user preference.

15. The method of claim 1, wherein controlling the first cooking resource based on the first cooking instruction of the cooking schedule utilizes an appliance accessory, wherein completion of the first instruction is determined by detecting the appliance accessory at the second cooking resource.

16. The method of claim 1, wherein automatically providing the secondary cooking instruction to the second cooking resource occurs in response to determining satisfaction of an initiation condition, associated with the secondary cooking instruction, based on an image captured by an optical sensor of the first cooking resource.

17. The method of claim 1, further comprising: determining a difference between a set of available ingredients and a set of ingredients associated with the cooking schedule; and ordering ingredients based on the difference.

18. A system comprising:
a cooking control system configured to:
determine a set of cooking resources;
determine a plurality of recipes, each recipe comprising cooking instructions and a set of intra-recipe dependencies specifying an intra-recipe order the cooking instructions;
determine a cooking schedule that minimizes a span between completion times of each of the plurality of recipes, wherein the cooking schedule comprises inter-recipe dependencies between cooking instructions of different recipes while preserving intra-recipe dependencies of each recipe; and
instruct the cooking resources according to the cooking schedule, comprising:
controlling a first cooking resource based on a first cooking instruction of the cooking schedule; and
automatically providing a secondary cooking instruction to a second cooking resource, separate from the first cooking resource, wherein the secondary cooking instruction execution is dependent on completion of the first cooking instruction.

19. The system of claim 18, wherein the cooking control system is further configured to determine a difference between a set of available ingredients and a set of cooking schedule ingredients; and order ingredients based on the difference.

20. The system of claim 18, further comprising a user database, wherein the cooking control system is further configured to determine the cooking schedule for the plurality of recipes based on historical data associated with a user stored in the user database.

21. The system of claim 18, further comprising a set of appliances, wherein the set of cooking resources comprises the set of appliances.
